(19) United States
(12) Patent Application Publication
(10) Pub. No.: US 2019/0255616 A1
(43) Pub. Date: Aug. 22, 2019

(54) METHODS OF FORMING POLYCRYSTALLINE COMPACTS

(71) Applicant: Baker Hughes, a GE company, LLC, Houston, TX (US)

(72) Inventors: Danny E. Scott, Montgomery, TX (US); Anthony A. DiGiovanni, Houston, TX (US); Gaurav Agrawal, Aurora, CO (US); Soma Chakraborty, Houston, TX (US)

(21) Appl. No.: 16/392,403

(22) Filed: Apr. 23, 2019

Related U.S. Application Data
(62) Division of application No. 13/650,876, filed on Oct. 12, 2012.
(60) Provisional application No. 61/547,472, filed on Oct. 14, 2011.

(51) Int. Cl. B22F 3/14; E21B 10/567; C04B 35/52; B82Y 30/00; B01J 3/06; B24D 99/00; C04B 35/56; C04B 35/565; C04B 35/5831; C04B 35/584; C04B 35/63; C04B 35/645; C22C 26/00

(52) U.S. Cl. CPC B22F 3/14; B22F 2005/001; C04B 35/52; B82Y 30/00; B01J 3/062; B24D 99/00; C04B 35/5607; C04B 35/5611; C04B 35/5626; C04B 35/565; C04B 35/5831; C04B 35/584; C04B 35/6303; C04B 35/645; C22C 26/00; C04B 2235/3206; E21B 10/567

(57) ABSTRACT

Polycrystalline compacts include a polycrystalline superabrasive material comprising a first plurality of grains of superabrasive material having a first average grain size and a second plurality of grains of superabrasive material having a second average grain size smaller than the first average grain size. The first plurality of grains is dispersed within a substantially continuous matrix of the second plurality of grains. Earth-boring tools may include a body and at least one polycrystalline compact attached thereto. Methods of forming polycrystalline compacts may include coating relatively larger grains of superabrasive material with relatively smaller grains of superabrasive material, forming a green structure comprising the coated grains, and sintering the green structure. Other methods include mixing diamond grains with a catalyst and subjecting the mixture to a pressure greater than about five gigapascals (5.0 GPa) and a temperature greater than about 1,300° C. to form a polycrystalline diamond compact.

### CROSS-REFERENCE TO RELATED APPLICATIONS

This application is a divisional of U.S. patent application Ser. No. 13/650,876, filed Oct. 12, 2012, pending, which claims the benefit of U.S. Provisional Patent Application Ser. No. 61/547,472, filed Oct. 14, 2011, in the name of Scott, et al., the disclosure of which is hereby incorporated herein in its entirety by this reference.

### TECHNICAL FIELD

The present disclosure relates generally to polycrystalline compacts, to tools including such compacts, and to methods of forming such polycrystalline compacts and tools.

### BACKGROUND

Earth-boring tools for forming boreholes in subterranean earth formations, such as for hydrocarbon production, carbon dioxide sequestration, etc., generally include a plurality of cutting elements secured to a body. For example, fixed-cutter earth-boring rotary drill bits (also referred to as “drag bits”) include cutting elements fixed to a bit body of the drill bit. Similarly, roller cone earth-boring rotary drill bits may include cones mounted on bearing pins extending from legs of a bit body such that each cone is capable of rotating about the bearing pin on which it is mounted. A plurality of cutting elements may be mounted to each cone of the drill bit.

The cutting elements used in such earth-boring tools often include polycrystalline diamond compact (often referred to as “PDC”) cutting elements, which are cutting elements that include cutting faces of a polycrystalline diamond (PCD) material. Polycrystalline diamond material is material that includes inter-bonded grains or crystals of diamond material. In other words, polycrystalline diamond material includes direct, inter-granular bonds between the grains or crystals of diamond material. The terms “grain” and “crystal” are used synonymously and interchangeably herein.

PDC cutting elements are formed by sintering and bonding diamond grains together under conditions of high pressure and temperature in the presence of a catalyst (e.g., cobalt, iron, nickel, or alloys and mixtures thereof) to form a layer or “table” of polycrystalline diamond material on a cutting element substrate. These processes are often referred to as high pressure/high temperature (or “HPHT”) processes. As shown in FIG. 1, a polycrystalline diamond table 10 may include fine diamond grains 12, coarse diamond grains 14, and catalyst material 16. The fine diamond grains 12 and coarse diamond grains 14 may be interspersed and inter-bonded. The cutting element substrate may comprise a cermet material (i.e., a ceramic-metal composite material) such as cobalt-cemented tungsten carbide. In such instances, the cobalt or other catalyst material in the cutting element substrate may be swept into the diamond grains during sintering and serve as the catalyst material 16 for forming the inter-granular diamond-to-diamond bonds between, and the resulting diamond table from, the diamond grains 12, 14. In other methods, powdered catalyst material 16 may be mixed with the diamond grains 12, 14 prior to sintering the grains together in an HPHT process.

Upon formation of a diamond table using an HPHT process, catalyst material 16 may remain in interstitial spaces between the grains of diamond 12, 14 in the resulting polycrystalline diamond table 10. The presence of the catalyst material 16 in the diamond table 10 may contribute to thermal damage in the diamond table 10 when the cutting element is heated due to friction at the contact point between the cutting element and the formation during use.

PDC cutting elements in which the catalyst material 16 remains in the diamond table 10 are generally thermally stable up to a temperature of about 750° C., although internal stress within the cutting element may begin to develop at temperatures exceeding about 400° C. due to phase changes in the metal catalyst (e.g., cobalt, which undergoes a transition from the beta phase to the alpha phase) and/or differences in the thermal expansion of the diamond grains 12, 14 and the catalyst material 16 at the grain boundaries. This difference in thermal expansion may result in relatively large tensile stresses at the interface between the diamond grains 12, 14, and may contribute to thermal degradation of the microstructure when PDC cutting elements are used in service. Differences in the thermal expansion between the diamond table 10 and the cutting element substrate to which it is bonded further exacerbate the stresses in the PDC. This differential in thermal expansion may result in relatively large compressive and/or tensile stresses at the interface between the diamond table 10 and the substrate that eventually lead to the deterioration of the diamond table 10, cause the diamond table to delaminate from the substrate, or result in the general ineffectiveness of the cutting element.

Furthermore, at temperatures at or above about 750° C., some of the diamond crystals 12, 14 within the diamond table may react with the catalyst material 16, causing the diamond crystals 12, 14 to undergo a chemical breakdown or conversion to another allotrope of carbon. For example, the diamond crystals 12, 14 may graphitize at the diamond crystal boundaries, which may substantially weaken the diamond table 10. At extremely high temperatures, some of the diamond crystals 12, 14 may be converted to carbon monoxide and/or carbon dioxide.

In order to reduce the problems associated with differences in thermal expansion and chemical breakdown of the diamond crystals in PDC elements, so-called “thermally stable” polycrystalline diamond compacts (which are also known as thermally stable products, or “TSPs”) have been developed. A TSP may be formed by leaching the catalyst material (e.g., cobalt) out from interstitial spaces between the inter-bonded diamond crystals in the diamond table using, for example, an acid or combination of acids (e.g., aqua regia). A substantial amount of the catalyst material may be removed from the diamond table, or catalyst material may be removed from only a portion thereof. TSPs in which substantially all catalyst material has been leached out from the diamond table have been reported to be thermally stable up to temperatures of about 1,200° C. It has also been reported, however, that such fully leached diamond tables are relatively more brittle and vulnerable to shear, compressive, and tensile stresses than are non-leached diamond tables. In addition, it is difficult to secure a completely leached diamond table to a supporting substrate. In an effort to provide cutting elements having diamond tables that are more thermally stable relative to non-leached diamond tables, but that are also relatively less brittle and vulnerable to shear, compressive, and tensile stresses relative to fully leached diamond tables, cutting elements have been provided that include a diamond table in which the catalyst material has been leached from a portion or portions of the diamond table. For example, it is known to leach catalyst material from the cutting face, from the side of the diamond table, or both, to a desired depth within the diamond table, but without leaching all of the catalyst material out from the diamond table.

### BRIEF SUMMARY

In some embodiments of the disclosure, a polycrystalline compact includes a polycrystalline superabrasive material. The polycrystalline superabrasive material includes a first plurality of grains of superabrasive material having a first average grain size and a second plurality of grains of superabrasive material having a second average grain size smaller than the first average grain size. The first plurality of grains is dispersed within a substantially continuous matrix of the second plurality of grains.

In other embodiments, an earth-boring tool includes a body and at least one polycrystalline compact attached to the body. The at least one polycrystalline compact comprises polycrystalline superabrasive material. The polycrystalline superabrasive material comprises a first plurality of grains of superabrasive material having a first average grain size and a second plurality of grains of superabrasive material having a second average grain size smaller than the first average grain size. The first plurality of grains is dispersed within a substantially continuous matrix of the second plurality of grains.

In some embodiments, a method of forming a polycrystalline compact includes coating relatively larger grains of superabrasive material with relatively smaller grains of superabrasive material, forming a green structure comprising the relatively larger grains coated with the relatively smaller grains, and sintering the green structure.

In other embodiments, methods of forming polycrystalline diamond compacts include mixing a first plurality of diamond grains with a second plurality of diamond grains and a catalyst for catalyzing the formation of diamond-to-diamond inter-granular bonds. The methods further include subjecting the mixture to a pressure greater than about five gigapascals (5.0 GPa) and a temperature greater than about 1,300° C. to form a polycrystalline diamond compact comprising the first plurality of diamond grains and the second plurality of diamond grains and forming a substantially continuous matrix comprising the second plurality of diamond grains in which the first plurality of diamond grains are embedded. The second plurality of diamond grains has an average grain size smaller than an average grain size of the first plurality of diamond grains.

### BRIEF DESCRIPTION OF THE DRAWINGS

While the specification concludes with claims particularly pointing out and distinctly claiming what are regarded as embodiments of the present disclosure, various features and advantages of this disclosure may be more readily ascertained from the description of example embodiments set forth below, when read in conjunction with the accompanying drawings, in which:

FIG. 1 is a simplified drawing showing how a conventional polycrystalline material may appear under magnification, and illustrates inter-bonded grains of hard material;

FIG. 2A illustrates an embodiment of a polycrystalline compact of the current disclosure;

FIG. 2B is an enlarged and simplified drawing illustrating how polycrystalline material of the polycrystalline compact of FIG. 2A may appear under magnification, and illustrates inter-bonded grains of hard material;

FIG. 2C is another enlarged and simplified drawing showing how polycrystalline material of the polycrystalline compact of FIG. 2A may appear under further magnification;

FIG. 3 is a simplified drawing showing how the polycrystalline material shown in FIG. 2B may appear after removing catalyst material from interstitial spaces, and illustrates inter-bonded grains of hard material; and

FIG. 4 is a perspective view of an embodiment of a fixed-cutter earth-boring rotary drill bit that includes a plurality of polycrystalline compacts like the polycrystalline compact shown in FIGS. 2A through 2C.

### DETAILED DESCRIPTION

The illustrations presented herein are not actual views of any particular polycrystalline compact, microstructure of polycrystalline material, particles, or drill bit, and are not drawn to scale, but are merely idealized representations employed to describe embodiments of the disclosure. Elements common between figures may retain the same numerical designation.

As used herein, the term “drill bit” means and includes any type of bit or tool used for drilling during the formation or enlargement of a wellbore and includes, for example, rotary drill bits, percussion bits, core bits, eccentric bits, bicenter bits, reamers, expandable reamers, mills, drag bits, roller cone bits, hybrid bits, and other drilling bits and tools known in the art.

The term “polycrystalline material” means and includes any material comprising a plurality of grains (i.e., crystals) of the material that are bonded directly together by inter-granular bonds. The crystal structures of the individual grains of the material may be randomly oriented in space within the polycrystalline material.

As used herein, the term “inter-granular bond” means and includes any direct atomic bond (e.g., ionic, covalent, metallic, etc.) between atoms in adjacent grains of material.

As used herein, the phrase “in situ nucleated grains” means and includes grains that are nucleated and grown in place within a polycrystalline material as the polycrystalline material is formed.

As used herein, the term “grain size” means and includes a geometric mean diameter measured from a 2D section through a bulk material. The geometric mean diameter for a group of particles may be determined using techniques known in the art, such as those set forth in Ervin E. Underwood, Quantitative Stereology, 103-105 (Addison-Wesley Publishing Company, Inc. 1970), which is incorporated herein in its entirety by this reference.

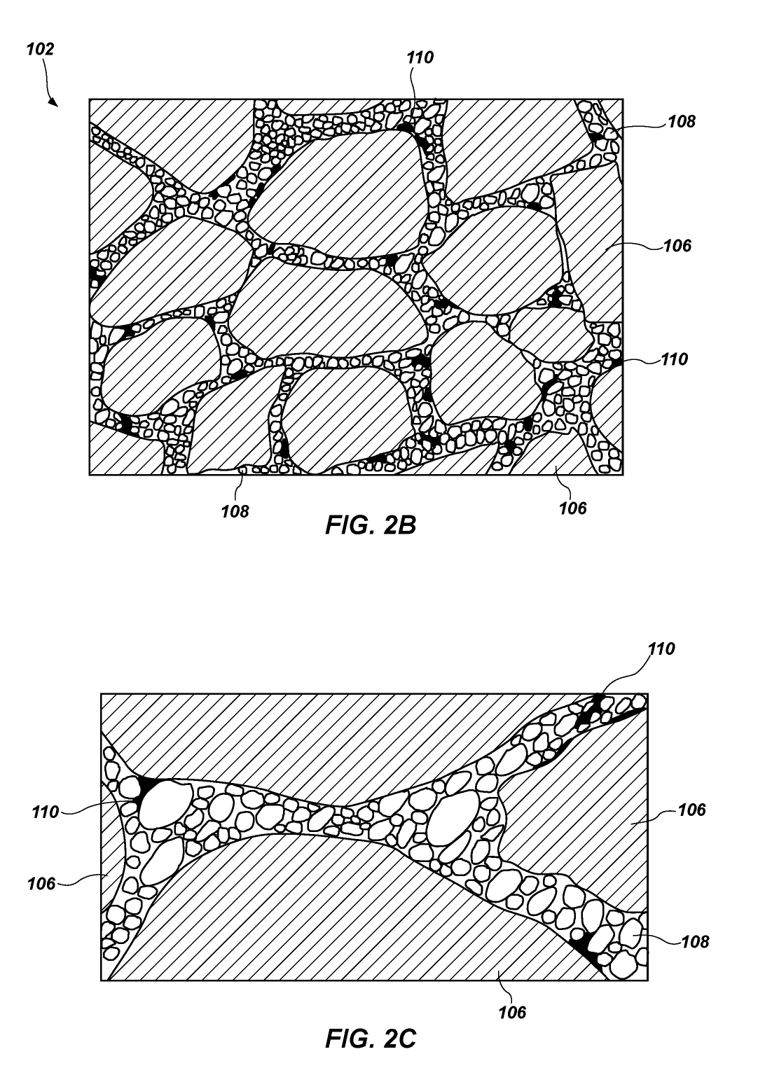

FIG. 2A is a simplified drawing illustrating an embodiment of a polycrystalline compact 100 of the present disclosure. The polycrystalline compact 100 includes a table or layer of hard polycrystalline material 102 that has been provided on (e.g., formed on or secured to) a surface of a supporting substrate 104. For example, the substrate 104 may include a generally cylindrical body of cobalt-cemented tungsten carbide material, although substrates of different geometries and compositions also may be employed. In additional embodiments, the polycrystalline compact 100 may simply comprise a volume of the hard polycrystalline material 102 having any desirable shape, and may not include any supporting substrate 104.

In some embodiments, the hard polycrystalline material 102 comprises polycrystalline diamond. In other embodiments, the hard polycrystalline material 102 may comprise another hard material, such as cubic boron nitride, silicon nitride, silicon carbide, titanium carbide, tungsten carbide, tantalum carbide, or another hard material. The hard polycrystalline material may comprise a superabrasive material.

FIG. 2B is an enlarged and simplified drawing schematically illustrating how a microstructure of the hard polycrystalline material 102 of the compact 100 (FIG. 2A) may appear under magnification. As shown in FIG. 2B, the grains of the hard polycrystalline material 102 have a multi-modal (e.g., bi-modal, tri-modal, etc.) grain size distribution. In other words, the hard polycrystalline material 102 includes a first plurality of grains 106 of hard material (e.g., a superabrasive material) having a first average grain size, and at least a second plurality of grains 108 of hard material (e.g., a superabrasive material) having a second average grain size that differs from the first average grain size of the first plurality of grains 106, such that a plot of the number of particles as a function of particle size has at least two peaks. For example, the first plurality of grains 106 may be relatively larger than the second plurality of grains 108.

The second plurality of grains 108 may be smaller than the first plurality of grains 106. While FIG. 2B illustrates the plurality of grains 108 as being smaller, on average, than the first plurality of grains 106, the drawing is not drawn to scale and has been simplified for purposes of illustration. In some embodiments, the difference between the average sizes of the first plurality of grains 106 and the second plurality of grains 108 may be greater than or less than the difference in the average grain sizes illustrated in FIG. 2B. For example, the average grain size of the larger grains 106 may be at least about five (5) times greater than the average grain size of the smaller grains 108, or at least about fifty (50) times greater than the average grain size of the smaller grains 108. In some embodiments, the average grain size of the larger grains 106 may be between about five (5) times and about three hundred times (300) greater than the average grain size of the smaller grains 108. The larger grains 106 and the smaller grains 108 may be interspersed and inter-bonded to form the hard polycrystalline material 102. In other words, in embodiments in which the hard polycrystalline material 102 comprises polycrystalline diamond, the larger grains 106 and the smaller grains 108 may be dispersed among and bonded directly to one another by inter-granular diamond-to-diamond bonds.

As known in the art, the average grain size of grains within a microstructure may be determined by measuring grains of the microstructure under magnification. For example, a scanning electron microscope (SEM), a field emission scanning electron microscope (FESEM), or a transmission electron microscope (TEM) may be used to view or image a surface of a hard polycrystalline material 102 (e.g., a polished and etched surface of the hard polycrystalline material 102). Commercially available vision systems or image analysis software are often used with such microscopy tools, and these vision systems are capable of measuring the average grain size of grains within a microstructure.

At least some of the smaller grains 108 of the hard polycrystalline material 102 may comprise in situ nucleated grains, as described in U.S. Patent Application Publication No. 2011/0031034 A1, published Feb. 10, 2011, and entitled “Polycrystalline Compacts Including In-Situ Nucleated Grains, Earth-Boring Tools Including Such Compacts, and Methods of Forming Such Compacts and Tools,” the entire disclosure of which is hereby incorporated by reference.

By way of example and not limitation, the average grain size of the smaller grains 108 may be between about five nanometers (5 nm) and about two microns (2 μm) (e.g., between about 50 nm and about 1 μm), and the average grain size of the larger grains 106 may be between about 5 μm and about 40 μm (e.g., between about 10 μm and about 15 μm). Thus, the smaller grains 108 may include nanoparticles in the microstructure of the hard polycrystalline material 102. Grains of various sizes may be used to form polycrystalline materials 102 of the present disclosure.

A large difference in the average grain size between the larger grains 106 and the smaller grains 108 may result in smaller interstitial spaces or voids within the microstructure of the hard polycrystalline material 102 (relative to conventional polycrystalline materials), and the total volume of the interstitial spaces or voids may be more evenly distributed throughout the microstructure of the hard polycrystalline material 102. As a result, any material present within the interstitial spaces (e.g., a catalyst material as described below) may also be more evenly distributed throughout the microstructure of the hard polycrystalline material 102 within the relatively smaller interstitial spaces therein.

In some embodiments, the number of smaller grains 108 per unit volume of the hard polycrystalline material 102 may be higher than the number of larger grains 106 per unit volume of the hard polycrystalline material 102, such as 10 times higher, 100 times higher, or even 1000 times higher than the number of larger grains 106 per unit volume of the hard polycrystalline material 102.

The smaller grains 108 may occupy between about two percent (2%) and about thirty percent (30%) of the volume of the hard polycrystalline material 102. More specifically, the smaller grains 108 may occupy between about 5% and about 15% of the volume of the hard polycrystalline material 102. The remainder of the volume of the hard polycrystalline material 102 may be substantially composed of the larger grains 106. A relatively small percentage of the remainder of the volume of the hard polycrystalline material 102 (e.g., less than about ten percent (10%), less than about five percent (5%), less than about two percent (2%), or less than about one percent (1%)) may include interstitial spaces between the smaller grains 108 and larger grains 106, which spaces may be at least partially filled with a catalyst or other material, as described below.

The larger grains 106 may be substantially or predominantly surrounded or coated by smaller grains 108. In some embodiments, the larger grains 106 may be bonded primarily or solely to smaller grains 108 by diamond-to-diamond bonds. The larger grains 106 may be non-contiguous and may be distributed in a contiguous matrix of the smaller grains 108. That is, the hard polycrystalline material 102 may be substantially free of diamond-to-diamond bonding directly between larger grains 106. The contiguity C of the distribution of the larger grains 106 may be defined as a ratio of the number of larger grains 106 having inter-granular bonds to other larger grains 106 along a plane to the total number of larger grains 106 along that plane:

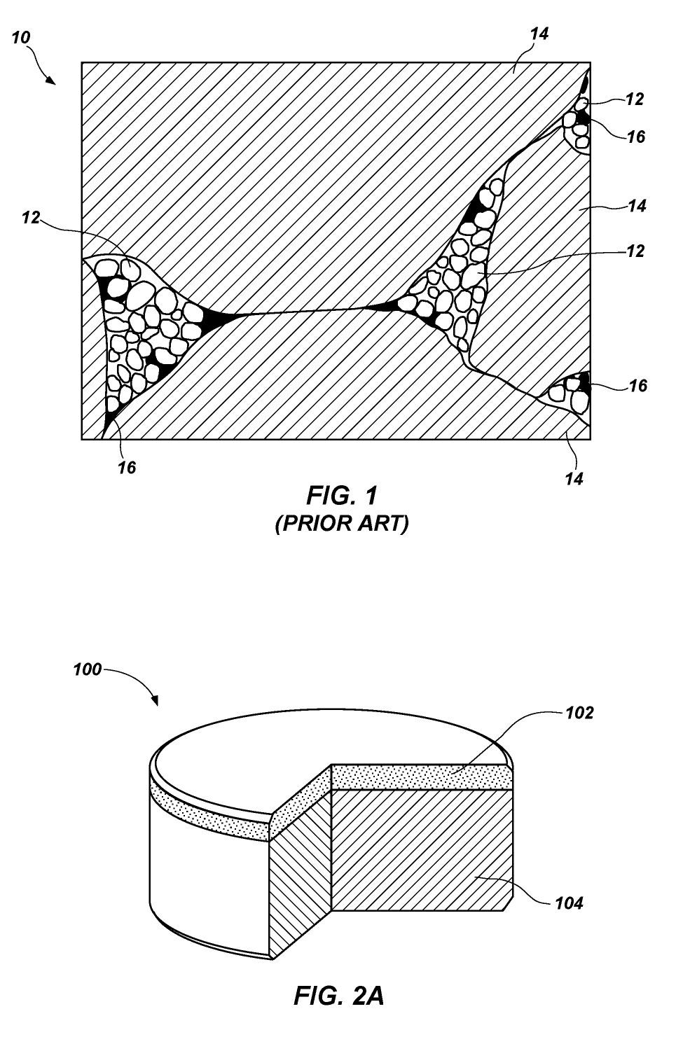

C=n_{b}/nₜₒₜ,

where n_{b} equals the number of larger grains 106 bonded directly to other larger grains 106 along the plane, and nₜₒₜ equals the total number of larger grains 106 along the plane. To determine this ratio, a hard polycrystalline material 102 may be cut along a plane. The number of larger grains 106 bonded directly to or in contact with other larger grains 106 (n_{b}) may be counted. The number of larger grains 106 within a particular area along the plane (nₜₒₜ) may also be counted. The ratio of these two numbers is a measure of the contiguity of the larger grains 106. A high contiguity (e.g., about 1.0) indicates that a high fraction of the larger grains 106 are bonded directly to other larger grains 106. For example, in the polycrystalline diamond table 10 shown in FIG. 1, the coarse diamond grains 14 have a contiguity of 1.0, because all the coarse diamond grains 14 are bonded directly to other coarse diamond grains 14. In embodiments of the present disclosure, such as shown in FIGS. 2B and 2C, the contiguity of the larger grains 106 may be less than about 0.9, less than about 0.6, less than about 0.3, less than about 0.2, less than about 0.1, less than about 0.05, or even less than about 0.01. That is, less than about 90%, less than about 60%, less than about 30%, less than about 20%, less than about 10%, less than about 5%, or even less than about 1% of the larger grains 106 may be in direct physical contact with other larger grains 106.

Smaller grains 108 may be disposed within spaces between adjacent larger grains 106. The smaller grains 108 may form a continuous network or matrix surrounding the larger grains 106. For example, as shown in FIG. 2C, individual larger grains 106 may not touch other larger grains 106 at all (i.e., the larger grains 106 may have a contiguity of about zero). Instead, the larger grains 106 may touch a plurality of smaller grains 108, which smaller grains 108 may touch other larger grains 106 and/or smaller grains 108. In contrast, in the polycrystalline diamond table 10 shown in FIG. 1, the coarse diamond grains 14 abut and are bonded directly to one another.

The low contiguity of the larger grains 106 of the present disclosure may limit the initiation and/or propagation of cracks within the hard polycrystalline material 102, in comparison with conventional polycrystalline materials. The presence of smaller grains also influences locally the amount of metal binder in unleached regions of the diamond table, and the metal binder content can be a toughening agent to crack propagation. The proportion of localized binder content on the grain-scale can be higher in these small grain regions than for a similarly sized microstructure having of larger grains.

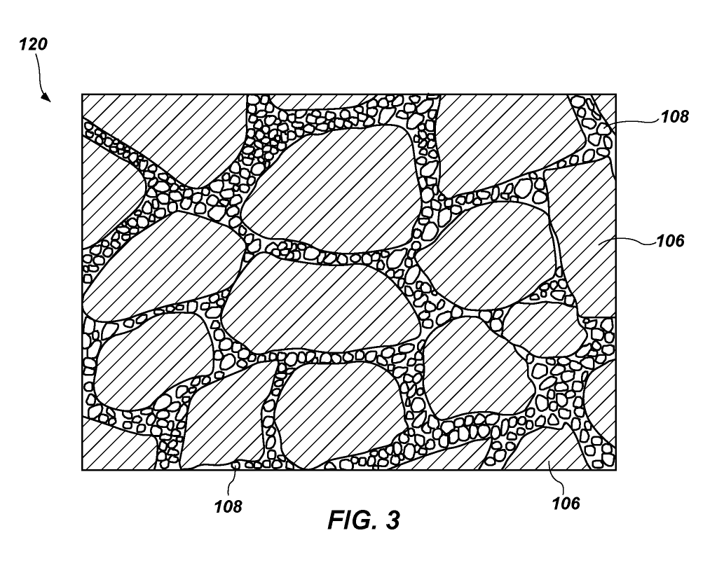

In some embodiments, the hard polycrystalline material 102 may include a catalyst material 110 (shaded black in FIGS. 2B and 2C) disposed in some interstitial spaces between the larger grains 106 and the smaller grains 108. The catalyst material 110 may comprise a catalyst material capable of forming (and used to catalyze the formation of) inter-granular bonds between the larger grains 106 and the smaller grains 108 of the hard polycrystalline material 102. In other embodiments, however, the interstitial spaces between the larger grains 106 and the smaller grains 108 in some regions of the hard polycrystalline material 102, or throughout the entire volume of the hard polycrystalline material 102, may be at least substantially free of such a catalyst material, as described below and shown in FIG. 3. In such embodiments, the interstitial spaces may comprise voids filled with gas (e.g., air), or the interstitial spaces may be filled with another material that is not a catalyst material or that will not contribute to degradation of the polycrystalline material 102 when the compact 100 is used in a drilling operation.

In embodiments in which the polycrystalline material 102 comprises polycrystalline diamond, the catalyst material 110 may comprise a Group VIII-A element (e.g., iron, cobalt, or nickel) or an alloy thereof, and the catalyst material 110 may comprise between about 0.1% and about 20% by volume of the hard polycrystalline material 102. In additional embodiments, the catalyst material 110 may comprise a carbonate material, such as a carbonate of one or more of Mg, Ca, Sr, and Ba. Carbonates may also be used to catalyze the formation of polycrystalline diamond.

The hard polycrystalline material 102 of the polycrystalline compact 100 may be formed using an HPHT process. In some embodiments, the hard polycrystalline material 102 may be formed on a supporting substrate 104 (as shown in FIG. 2A) of cemented tungsten carbide or another suitable substrate material in a conventional HPHT process of the type described, by way of non-limiting example, in U.S. Pat. No. 3,745,623, issued Jul. 17, 1973, entitled “Diamond Tools for Machining,” or may be formed as a freestanding polycrystalline compact (i.e., without the supporting substrate 104) in a similar conventional HPHT process as described, by way of non-limiting example, in U.S. Pat. No. 5,127,923, issued Jul. 7, 1992,entitled “Composite Abrasive Compact Having High Thermal Stability,” the disclosure of each of which is incorporated herein in its entirety by this reference. In some embodiments, the catalyst material 110 may be supplied from the supporting substrate 104 during an HPHT process used to form the hard polycrystalline material 102. For example, the substrate 104 may be a cobalt-cemented tungsten carbide material. Cobalt of the cobalt-cemented tungsten carbide may serve as the catalyst material 110 during the HPHT process.

To form the hard polycrystalline material 102 in an HPHT process, a particulate mixture including grains of hard material, and optionally including nucleation particles (as described in U.S. Patent Application Publication No. 2011/0031034 A1, previously incorporated by reference) may be subjected to elevated temperatures (e.g., temperatures greater than about 1,300° C.) and elevated pressures (e.g., pressures greater than about 5.0 gigapascals (GPa)) to form inter-granular bonds between the grains, thereby forming the hard polycrystalline material 102. In some embodiments, the particulate mixture may be subjected to a pressure greater than about six gigapascals (6.0 GPa) and a temperature greater than about 1,500° C. in the HPHT process.

For example, a particulate mixture may be formed by coating the larger grains 106 with the smaller grains 108. Smaller grains 108 may be coated onto the larger grains 106 by a variety of means including but not limited to layer-by-layer processes, fluidized-bed reactions, electrospraying, sol-gel coating, or similar methods as known in the art. For example, the coating of larger grains 106 with smaller grains 108 may be performed as described in N. Ellis, et al., “Development of a Continuous Nanoparticle Coating with Electrospraying,” 2010 ECI Conference on the 13^{th} Intl. Conference on Fluidization, paper 46, 2011, available at http://services.bepress.com/eci/fluidization_xiii/46/, which is incorporated herein in its entirety by this reference. In some embodiments, the larger grains 106 may be rolled or blended with the smaller grains 108 and a binder material. The binder material may promote adhesion of the grains 106, 108, such that larger grains 106 become coated with the smaller grains 108. The binder material may include an organic material, such as a material that binds to the larger grains 106 and the smaller grains 108 and decomposes at temperatures well below HPHT processing temperatures (e.g., below about 500° C., below about 300° C., or even below about 200° C.). Examples of organic binders include polyethylene, polyethylene-butyl acetate (PEBA), ethylene vinyl acetate (EVA), ethylene ethyl acetate, polyethylene glycol (PEG), polypropylene (PP), poly vinyl alcohol (PVA), polystyrene (PS), polymethyl methacrylate, polyethylene carbonate (PEC), polyalkylene carbonate (PAC), polycarbonate, poly propylene carbonate (PPC), nylons, polyvinyl chlorides, polybutenes, polyesters, etc. In other embodiments, the binder material can include, for example, aqueous and gelation polymers or inorganic polymers. Suitable aqueous and gelation polymers may include those formed from cellulose, alginates, polyvinyl alcohol, polyethylene glycol, polysaccharides, water, and mixtures thereof. Silicone is an example of an inorganic polymer binder. Other binder materials may include wax or natural and synthetic oil (e.g., mineral oil) and mixtures thereof. It is contemplated that one of ordinary skill in the art may find other binder materials useful for promoting adhesion of the grains 106, 108.

Either the larger grains 106, the smaller grains 108, or both, may be selected to include diamond. The mixture may optionally be combined with a catalyst material, such as cobalt, iron, nickel, or combinations thereof. The mixture may then be formed into a green (i.e., unsintered) structure. The green structure may be sintered or partially sintered, such as in an HPHT process. In some embodiments, the mixture may be subjected to a pressure greater than about 5.0 GPa and a temperature greater than about 1,000° C. to form a polycrystalline compact (e.g., a pressure greater than about 6.5 GPa and a temperature greater than about 1,500° C.). A continuous network of the smaller grains 108 may be formed during sintering by catalyzing the formation of inter-granular bonds (e.g., diamond-to-diamond bonds) between adjacent smaller grains 108. The presence of the catalyst may promote the formation of inter-granular bonds. The catalyst may be removed from the polycrystalline compact after sintering (and thus, after the formation of inter-granular bonds), such as by immersing the polycrystalline compact in a leaching agent.

The time at the elevated temperatures and pressures may be kept relatively short, when compared to conventional HPHT processes, to prevent growth of the larger grains 106 and shrinkage (i.e., dissolution) of the smaller grains 108. For example, the particulate mixture may be subjected to a pressure greater than 6.5 GPa and a temperature greater than about 1,500° C. for less than about two minutes (2.0 min.) during the HPHT process.

In embodiments in which a catalyst material 110 includes a carbonate (e.g., a carbonate of one or more of Mg, Ca, Sr, and Ba) to catalyze the formation of polycrystalline diamond, the particulate mixture may be subjected to a pressure greater than about 7.7 GPa and a temperature greater than about 2,000° C. The particulate mixture may include the larger grains 106 previously described herein. The particulate mixture may also include catalyst material 110. In some embodiments, the particulate material may include a powder-like substance. In other embodiments, however, the particulate material may be carried by (e.g., on or in) another material, such as a paper or film, which may be subjected to the HPHT process.

In some embodiments, parameters of the HPHT process (e.g., temperature, pressure, time, etc.) may be selectively controlled to form in situ nucleated smaller grains 108 of hard material within the resulting hard polycrystalline material 102. Thus, the smaller grains 108 of hard material may be nucleated and catalyzed in the presence of the larger grains 106 of hard material, and the formation of inter-granular bonds between the larger grains 106 and the smaller grains 108 of hard material may be catalyzed.

As previously described, catalyst material may promote the formation of the inter-granular bonds between smaller grains 108 and the larger grains 106 during the HPHT process. After the HPHT process, some catalyst material 110 may remain in the interstitial spaces between the inter-bonded smaller grains 108 and larger grains 106.

Optionally, catalyst material 110 may be removed from the hard polycrystalline material 102 after the HPHT process, as known in the art, to form a leached polycrystalline material 120 (FIG. 3). For example, a leaching process may be used to remove catalyst material 110 from interstitial spaces between the inter-bonded grains of the hard polycrystalline material 102. By way of example and not limitation, the hard polycrystalline material 102 may be leached using a leaching agent and process such as those described in, for example, U.S. Pat. No. 5,127,923, previously incorporated by reference, and U.S. Pat. No. 4,224,380, issued Sep. 23, 1980, and entitled “Temperature Resistant Abrasive Compact and Method for Making Same,” the disclosure of which is incorporated herein in its entirety by this reference. Specifically, aqua regia (a mixture of concentrated nitric acid (HNO₃) and concentrated hydrochloric acid (HCl)) may be used to at least substantially remove catalyst material from the interstitial spaces between inter-bonded grains in the hard polycrystalline material 102. Boiling hydrochloric acid (HCl) or boiling hydrofluoric acid (HF) may also be used as leaching agents. One suitable leaching agent is hydrochloric acid (HCl) at a temperature above 110° C., which may be provided in contact with the hard polycrystalline material 102 for a period of about two (2) hours to about sixty (60) hours, depending upon the size of the body comprising the hard polycrystalline material 102. After leaching the hard polycrystalline material 102, interstitial spaces between the inter-bonded grains within the leached polycrystalline material 120 may be at least substantially free of catalyst material 110 used to catalyze formation of inter-granular bonds between the grains.

The overall polycrystalline microstructure that may be achieved in accordance with embodiments of the present disclosure may result in polycrystalline diamond compacts that exhibit improved durability and thermal stability, such as a decreased propensity for crack propagation.

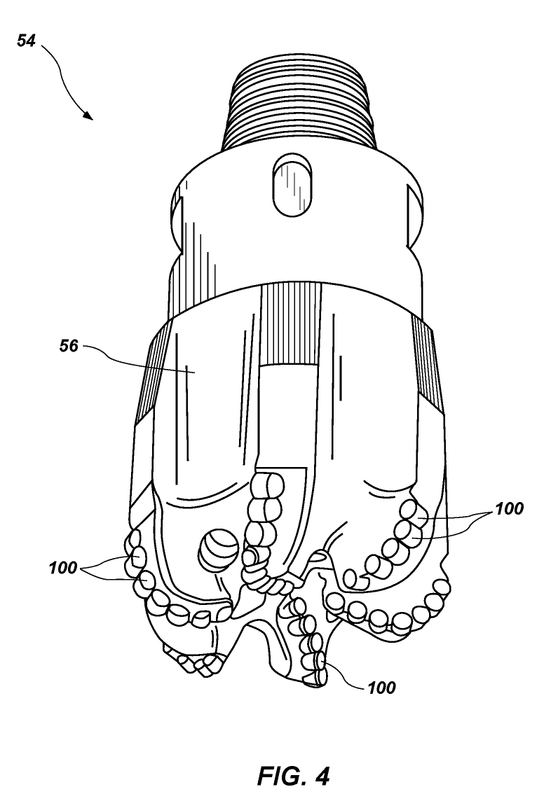

Polycrystalline compacts that embody teachings of the present disclosure, such as the polycrystalline compact 100 illustrated in FIGS. 2A through 2C, and the leached polycrystalline material 120 illustrated in FIG. 3, may be formed and secured to drill bits for use in forming wellbores in subterranean formations. As a non-limiting example, FIG. 4 illustrates a fixed cutter type earth-boring rotary drill bit 54 that includes a plurality of polycrystalline compacts 100 as previously described herein. The earth-boring rotary drill bit 54 includes a bit body 56, and the polycrystalline compacts 100, which serve as cutting elements, are mounted on the bit body 56 of the drill bit 54. The polycrystalline compacts 100 may be brazed or otherwise secured within pockets formed in the outer surface of the bit body 56. Other types of earth-boring tools, such as roller cone bits, percussion bits, hybrid bits, reamers, etc., also may include cutting elements 100 as described herein.

Additional non-limiting example embodiments of the disclosure are described below.

### EMBODIMENT 1

A polycrystalline compact comprising a polycrystalline superabrasive material comprising, a first plurality of grains of superabrasive material having a first average grain size, and a second plurality of grains of superabrasive material having a second average grain size smaller than the first average grain size. The first plurality of grains is dispersed within a substantially continuous matrix of the second plurality of grains.

### EMBODIMENT 2

The polycrystalline compact of Embodiment 1, wherein each of the first plurality of grains is at least substantially surrounded by grains of the second plurality of grains.

### EMBODIMENT 3

The polycrystalline compact of Embodiment 1 or Embodiment 2, wherein about 20% or less of the first plurality of grains are in direct physical contact with others of the first plurality of grains.

### EMBODIMENT 4

The polycrystalline compact of Embodiment 3, wherein about 10% or less of the first plurality of grains are in direct physical contact with others of the first plurality of grains.

### EMBODIMENT 5

The polycrystalline compact of any of Embodiments 1 through 4, wherein the first plurality of grains of superabrasive material and the second plurality of grains of superabrasive material comprise the same superabrasive material.

### EMBODIMENT 6

The polycrystalline compact of any of Embodiments 1 through 5, wherein the first average grain size is between about five microns (5 μm) and about forty microns (40 μm).

### EMBODIMENT 7

The polycrystalline compact of Embodiment 6, wherein the second average grain size is between about five nanometers (5 nm) and about two microns (2 μm).

### EMBODIMENT 8

The polycrystalline compact of any of Embodiments 1 through 7, wherein the second plurality of grains comprise between about five percent (5%) and about thirty percent (30%) by volume of the polycrystalline superabrasive material.

### EMBODIMENT 9

The polycrystalline compact of Embodiment 8, wherein the second plurality of grains comprise between about five percent (5%) and about fifteen percent (15%) by volume of the polycrystalline superabrasive material.

### EMBODIMENT 10

The polycrystalline compact of any of Embodiments 1 through 9, further comprising a catalyst material disposed in at least some interstitial spaces between the first plurality of grains of superabrasive material and the second plurality of grains of superabrasive material.

### EMBODIMENT 11

The polycrystalline compact of any of Embodiments 1 through 10, wherein the polycrystalline superabrasive material comprises polycrystalline diamond.

### EMBODIMENT 12

An earth-boring tool comprising a body and at least one polycrystalline compact attached to the body. The at least one polycrystalline compact comprises polycrystalline superabrasive material. The polycrystalline superabrasive material comprises a first plurality of grains of superabrasive material having a first average grain size and a second plurality of grains of superabrasive material having a second average grain size smaller than the first average grain size. The first plurality of grains is dispersed within a substantially continuous matrix of the second plurality of grains.

### EMBODIMENT 13

A method of forming a polycrystalline compact, comprising coating relatively larger grains of superabrasive material with relatively smaller grains of superabrasive material, forming a green structure comprising the relatively larger grains coated with the relatively smaller grains, and sintering the green structure.

### EMBODIMENT 14

The method of Embodiment 13, further comprising selecting the superabrasive material of each of the relatively larger grains and the relatively smaller grains to comprise diamond.

### EMBODIMENT 15

The method of Embodiment 13 or Embodiment 14, further comprising mixing a catalyst material comprising at least one of cobalt, iron, and nickel with the relatively larger grains.

### EMBODIMENT 16

The method of any of Embodiments 13 through 15, wherein coating relatively larger grains of superabrasive material with relatively smaller grains of superabrasive material comprises electrospraying the relatively smaller grains of superabrasive material over the relatively larger grains of superabrasive material.

### EMBODIMENT 17

The method of any of Embodiments 13 through 16, further comprising selecting each of the relatively larger grains of hard material and the relatively smaller grains of hard material to comprise a material selected from the group consisting of diamond, cubic boron nitride, silicon nitride, silicon carbide, titanium carbide, tungsten carbide, and tantalum carbide.

### EMBODIMENT 18

A method of forming a polycrystalline diamond compact, comprising mixing a first plurality of diamond grains with a second plurality of diamond grains and a catalyst for catalyzing the formation of diamond-to-diamond inter-granular bonds, and subjecting the mixture to a pressure greater than about five gigapascals (5.0 GPa) and a temperature greater than about 1,300° C. to form a polycrystalline diamond compact comprising the first plurality of diamond grains and the second plurality of diamond grains and forming a substantially continuous matrix comprising the second plurality of diamond grains in which the first plurality of diamond grains are embedded. The second plurality of diamond grains has an average grain size smaller than an average grain size of the first plurality of diamond grains.

### EMBODIMENT 19

The method of Embodiment 18, further comprising forming the polycrystalline diamond compact such that each diamond grain of the first plurality is at least substantially entirely surrounded by diamond grains of the second plurality.

### EMBODIMENT 20

The method of Embodiment 18 or Embodiment 19, further comprising forming the polycrystalline diamond compact such that about 90% or less of the diamond grains of the first plurality are in direct physical contact with other diamond grains of the first plurality.

### EMBODIMENT 21

The method of Embodiment 20, further comprising forming the polycrystalline diamond compact such that about 60% or less of the diamond grains of the first plurality are in direct physical contact with other diamond grains of the first plurality.

### EMBODIMENT 22

The method of Embodiment 21, further comprising forming the polycrystalline diamond compact such that about 30% or less of the diamond grains of the first plurality are in direct physical contact with other diamond grains of the first plurality.

### EMBODIMENT 23

The method of any of Embodiments 18 through 22, wherein subjecting the mixture to a pressure greater than about five gigapascals (5.0 GPa) and a temperature greater than about 1,300° C. comprises subjecting the mixture to a pressure greater than about 6.5 GPa and a temperature greater than about 1,500° C. for less than about two minutes (2.0 min.).

While the present disclosure has been described with respect to certain embodiments, those of ordinary skill in the art will recognize and appreciate that it is not so limited. Rather, many additions, deletions and modifications to the embodiments described herein may be made without departing from the scope of the invention as hereinafter claimed, including legal equivalents. In addition, features from one embodiment may be combined with features of another embodiment while still being encompassed within the scope of the invention as contemplated by the inventors. Further, embodiments of the disclosure have utility with different and various bit profiles as well as cutting element types and configurations.

1. A method of forming a polycrystalline compact, comprising:
coating relatively larger grains of superabrasive material with relatively smaller grains of superabrasive material, the relatively larger grains having a first average grain size between about five microns (5 μm) and about forty microns (40 μm), the relatively smaller grains having a second average grain size between about five nanometers (5 nm) and about two microns (2 μm);
forming a green structure comprising the relatively larger grains coated with the relatively smaller grains; and
sintering the green structure to form in-situ nucleated grains of hard material, a continuous matrix of the relatively smaller grains, and inter-granular bonds between the relatively larger grains and the relatively smaller grains, wherein the relatively larger grains are dispersed within the continuous matrix, and wherein at least some of the relatively larger grains are non-contiguous.

2. The method of claim 1, further comprising selecting the superabrasive material of each of the relatively larger grains and the relatively smaller grains to comprise diamond.

3. The method of claim 1, further comprising mixing a catalyst material comprising at least one of cobalt, iron, and nickel with the relatively larger grains coated with the relatively smaller grains.

4. The method of claim 1, wherein coating relatively larger grains of superabrasive material with relatively smaller grains of superabrasive material comprises electrospraying the relatively smaller grains of superabrasive material over the relatively larger grains of superabrasive material.

5. The method of claim 1, further comprising selecting each of the relatively larger grains of hard material and the relatively smaller grains of hard material to comprise a material selected from the group consisting of diamond, cubic boron nitride, silicon nitride, silicon carbide, titanium carbide, tungsten carbide, and tantalum carbide.

6. A method of forming a polycrystalline diamond compact, comprising:
mixing a first plurality of diamond grains with a second plurality of diamond grains and a catalyst for catalyzing the formation of diamond-to-diamond inter-granular bonds, the first plurality of grains having a first average grain size between about five microns (5 μm) and about forty microns (40 μm), the second plurality of grains having a second average grain size between about five nanometers (5 nm) and about two microns (2 μm); and
subjecting the mixture to a pressure greater than about five gigapascals (5.0 GPa) and a temperature greater than about 1,300° C. to form a polycrystalline diamond compact comprising the first plurality of diamond grains and the second plurality of diamond grains and to form a continuous matrix comprising the second plurality of diamond grains in which the first plurality of diamond grains are embedded, wherein at least some of the first plurality of grains are non-contiguous.

7. The method of claim 6, further comprising forming the polycrystalline diamond compact such that each diamond grain of the first plurality is at least substantially entirely surrounded by diamond grains of the second plurality.

8. The method of claim 6, further comprising forming the polycrystalline diamond compact such that about 90% or less of the diamond grains of the first plurality are in direct physical contact with other diamond grains of the first plurality.

9. The method of claim 8, further comprising forming the polycrystalline diamond compact such that about 60% or less of the diamond grains of the first plurality are in direct physical contact with other diamond grains of the first plurality.

10. The method of claim 9, further comprising forming the polycrystalline diamond compact such that about 30% or less of the diamond grains of the first plurality are in direct physical contact with other diamond grains of the first plurality.

11. The method of claim 6, wherein subjecting the mixture to a pressure greater than about five gigapascals (5.0 GPa) and a temperature greater than about 1,300° C. comprises subjecting the mixture to a pressure greater than about 6.5 GPa and a temperature greater than about 1,500° C. for less than about two minutes (2.0 min.).

12. The method of claim 6, further comprising forming the polycrystalline diamond compact such that about 10% or less of the first plurality of grains are in direct physical contact with others of the first plurality of grains.

14. The method of claim 6, wherein mixing a first plurality of diamond grains with a second plurality of diamond grains comprises mixing the first plurality of diamond grains having the first average grain size that is between about five (5) times and about three hundred (300) times greater than the second average grain size with the second plurality of diamond grains.

15. The method of claim 6, wherein subjecting the mixture to a pressure greater than about five gigapascals (5.0 GPa) and a temperature greater than about 1,300° C. comprises forming in-situ nucleated diamond grains between the first plurality of diamond grains and the second plurality of diamond grains.

16. The method of claim 6, further comprising forming the polycrystalline diamond compact such that less than about 5% of a volume of the polycrystalline diamond compact comprises interstitial spaces filled with the catalyst.

16. The method of claim 1, further comprising forming the polycrystalline compact such that about 30% or less of the relatively larger grains are in direct physical contact with other grains of the relatively larger grains.

17. The method of claim 1, further comprising forming the polycrystalline diamond compact such that about 10% or less of the relatively larger grains are in direct physical contact with other grains of the relatively larger grains.

18. The method of claim 6, further comprising selecting the relatively larger grains and the relatively smaller grains to comprise the same superabrasive material.

19. The method of claim 1, further comprising forming the polycrystalline compact such that each grain of the relatively larger grains is at least substantially entirely surrounded by grains of the relatively smaller grains.

20. The method of claim 1, further comprising selecting the relatively larger grains to have the first average grain size that is between about five (5) times and about three hundred (300) times greater than the second average grain size of the relatively smaller grains.
